(19) United States
(12) Patent Application Publication
(10) Pub. No.: US 2002/0164012 A1
(43) Pub. Date: Nov. 7, 2002

(54) Method for providing information

(76) Inventor: Eyal Sadot, Doar Akko (IL)

Correspondence Address: BROWDY AND NEIMARK, P.L.L.C., 624 NINTH STREET, NW, SUITE 300, WASHINGTON, DC, 20001-5303, US

(21) Appl. No.: 09/845,251

(22) Filed: May 1, 2001

(51) Int. Cl. H04M 3/00; H04M 5/00

(52) U.S. Cl. 379/267

(57) ABSTRACT

A method for providing details of a service to an end user. The method comprises (a) the end user dialing a single access telephone number, the single access telephone number connecting the end user to a human operator; (b) the end user requesting from the operator details of a service; and (c) the operator providing the end user with the details from a list of service providers. The operator obtains the details from a provider of the service who pays for having his name included in the operator's list. Also disclosed is a system for providing details of a service to an end user.

### FIELD OF THE INVENTION

This invention relates to a method of providing information to a caller by telephone.

### BACKGROUND OF THE INVENTION

A well known technique of advertising is the use of the classified section of a telephone book. In the classified section (also known as the “yellow pages”), information regarding providers of various goods and services is classified according to types of concerns. The providers pay the publisher of the classified section for the opportunity to advertise various pieces of information in the section regarding their concern, including their name, address and telephone number. A consumer who requires a certain good or service locates the desired type of service in the classified section, and then chooses one or more providers which he wishes to contact from a list of providers appearing under the desired type of service. This method of advertising is also available today through the Internet.

However, for some people and under certain circumstances, the above system is inconvenient. Not everyone has the patience and time to page or browse through the classified section, and it is not always self-evident under which classification a desired service may be found.

U.S. Pat. No. 4,757,267 discloses a telephone system which automatically connects a potential customer with a nearby dealer. The customer dials an “800”-type number which includes digits uniquely characteristic of the product or service desired. A computer routes the call to a customer-dealer service company in the vicinity of the customer. This company then determines the present location of appropriate dealers and automatically routes the call of the customer to the nearest dealer.

U.S. Pat. No. 5,136,636 discloses an arrangement for selecting a local dealer out of a large group of dealers. A caller dials an “800” number to a toll switching system which sends a query to a first database. The first database responds with a routing number which is used to route a second query to a plurality of second databases which contain the telephone number of local dealers. The telephone number is then returned to the toll system for completing the call.

U.S. Pat. No. 5,873,032 discloses a method and system for providing directory assistance services. A subscriber who requires assistance in locating a certain telephone number is connected to an operator who identifies the desired number. The operator initiates the call for the subscriber and continues to monitor the call until the called party responds. If there is no response, the operator provides the subscriber with a menu of options for further assistance in leaving a message, redialing, etc.

U.S. Pat. No. 6,058,179 discloses a one number, multi-application, intelligent call processing system. The system utilizes voice response unit technology, and involves the creation of a virtual telephone number database for use with a computer telephone integration network. The caller is automatically connected with a servicing location near the caller.

### SUMMARY OF THE INVENTION

It is an object of the present invention to provide a method for locating the telephone number of a service provider.

Thus, in a first aspect, the present invention provides a method for providing details of a service to an end user comprising:

(i) the end user dialing a single access telephone number, the single access telephone number connecting the end user to a human operator;

(ii) the end user requesting from the operator details of a service; and

(iii) the operator providing the end user with the details;

wherein the operator obtains the details from a provider of the service.

As opposed to several prior art methods, the method of the present invention is based on a telephone call made between two human beings—the caller or end user and a telephone operator. The end user obtains the desired information by conversing with a human telephone operator rather than by interacting with a faceless computer. Many consumers prefer interacting with a human being rather than interacting with a recording. The method of the invention does not provide mere directory assistance for locating a telephone number, but rather assists the end user in locating a service provider appropriate to his needs. Thus, the method of the invention is much more “user friendly” than other prior art methods.

In the present specification, the term “service” is intended to include all types of services, goods and information which an end user may be interested in obtaining. Examples of services obtained through the method of the invention are listed in the classified section of any telephone book. However, the invention is not limited to these and also includes other types of services, goods and information such as weather reports, transportation timetables, financial information, government offices, etc.

(i) The “details” provided by the operator to the end user may include, but are not limited to, the name, address, telephone and fax numbers, E-mail and internet addresses of the service provider, his availability (i.e. 9:00-17:00, 24 hours, 5 days a week, etc.), and miscellaneous details regarding the manner in which the service is provided (minimum fee, makes of products, etc.).

In the first step of the method of the invention, the end user dials a single access telephone number. The method uses a number such as an “800”-type number, so that all types of queries are made using one, easy-to-remember telephone number. Preferably, calling this number is without charge to the end user. In a preferred embodiment discussed below, the service provider is billed for the call.

The end user is then connected to a human telephone operator who determines by conversing with the end user what service is required. In determining the desired service, the operator takes into account, among others, (a) the type of service; (b) the geographical location of the end user and provider of the service; and (c) the availability of the service provider. The operator has at his disposal lists of service providers for each type of service. The lists may be on paper, on computer, or by any other listing means. The service providers themselves provide the items in the list from which the operator chooses. Thus, a commercial interaction exists between the operator (or the firm of which he is an employee) and the service provider, as will be further explained below.

Once the operator determines the requirements of the end user, he forms a subset of service providers which fulfill the requirements of the end user. He then provides the end user with the details of one or more service providers who fulfill the requirements. Preferably, the operator will provide the end user with details of 1-3 service providers. In a preferred embodiment, the operator directly connects the end user to the service provider by telephone (call completion), if so desired by the end user.

The commercial aspect of the method of the invention is similar to that of the classified section of the telephone book. Various service providers may contact an enterprise which wishes to provide an information service according to the method of the invention. The service providers may provide the enterprise with details of their service, as defined above. Preferably, each service provider compensates the enterprise for including the details of its service in the lists of service providers. The enterprise compiles names of various types of services, and classifies the service providers according to the different service types. A service provider may be classified in more than one type.

When the operator (who is an employee of the enterprise) wishes to choose a service provider from the lists at his disposal, he will preferably do so in a random fashion, for example using a computer program. Preferably a computer program is used in order to ensure that all of the appropriate service providers are chosen at least once and that none of the service providers is favored over the others. In order to increase the probability that his service will be chosen, the service provider may request that the enterprise include his service a plurality of times in the list, while paying suitable compensation to the enterprise.

As mentioned above, the enterprise may charge the service provider, whose details were provided to the end user, for the call of the end user to the operator. The enterprise may also provide the service provider with a list of end user users who received its telephone number.

The method of the invention is illustrated schematically in FIG. 1.

In a second aspect of the invention, there is provided a system for providing details of a service to an end user. The system comprises: (a) a collection of the details of service providers of different types of services; (b) a human telephone operator; and (c) a single access telephone number through which the end user may contact the operator.

### BRIEF DESCRIPTION OF THE DRAWING

FIG. 1 is a flow diagram illustrating one embodiment of the invention.

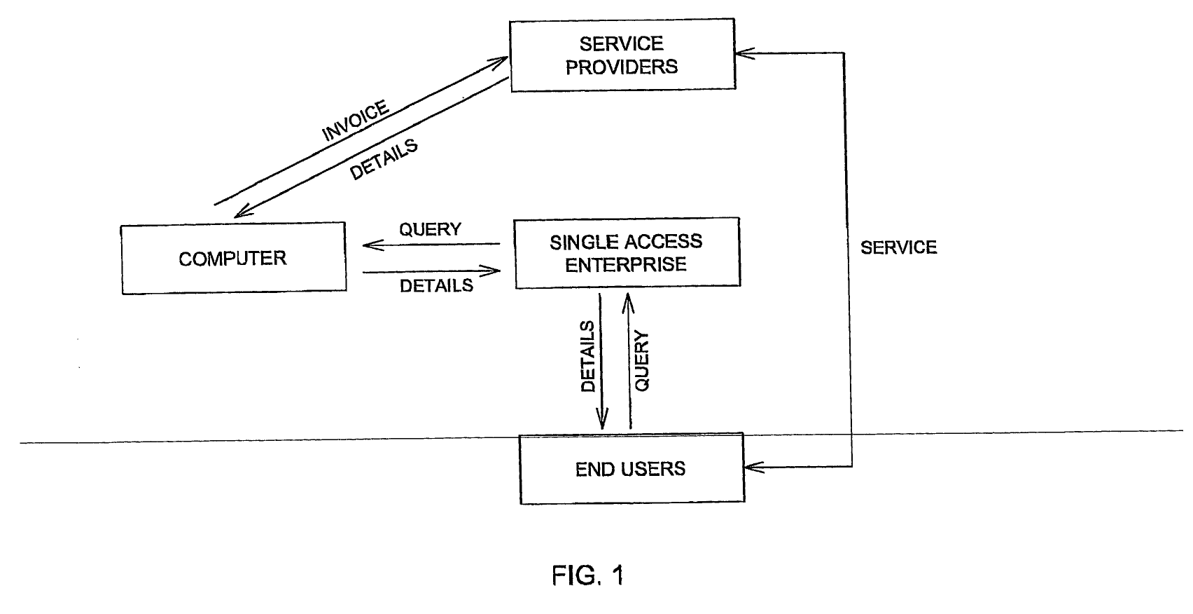

### DETAILED DESCRIPTION OF THE INVENTION

The invention will now be illustrated by the following examples. However, the scope of the invention is not limited to the scope of the examples.

### EXAMPLE 1

Jack's washing machine broke down in the middle of the night. Jack needs it fixed immediately, but doesn't know how to find a repair man who will be willing to come out to his apartment in the middle of the night. Jack calls the single access telephone number (without charge) and speaks to the night operator. The operator consults (through a computer) her list of washing machine repairmen, and creates a subset of repairmen who operate in the area of Jack's apartment, and who are willing to work in the middle of the night. She then randomly chooses (using an appropriate computer program for choosing from a list by random) 3 repairmen and provides Jack with their details. Jack chooses one and requests the operator to complete the call to the chosen repairman. The chosen repairman is not available, so Jack contacts the second repairman, who comes and repairs the washing machine. The second repairman is billed for Jack's call to the operator.

### EXAMPLE 2

Mary wants to buy a suit for her sister's new baby, but doesn't know what stores sell such a clothing article. Mary calls the single access telephone number (without charge) and speaks to the operator. The operator consults her list of clothing stores carrying baby clothing, and creates a subset of stores located in the area where Mary lives. She then randomly chooses the “Baby Store” and provides Mary with its details. Since the proprietor of the Baby Store has paid for the name of his store to appear 10 times in the appropriate class, the name of his store comes up more often than the names of other stores which appear only once in the same class. Mary goes to the store at her leisure, having been informed of its working hours by the operator.

### EXAMPLE 3

Robert wants to know how his stock is doing on Wall Street, but doesn't want to bother his broker. Robert calls the single access telephone number and requests the telephone number of a financial analyst who will be willing to provide him with the information he wants at no charge. The operator consults his list of financial analysts and creates a subset of analysts who fulfill Robert's requirements. The subset contains 10 names, four of which were already give to other end users. The operator therefore randomly chooses two names from the six previously unchosen names, whose telephone numbers are provided to Robert.

### EXAMPLE 4

John broke his eyeglasses. He remembers the name of his optometrist but not his telephone number. A call to the single access telephone number provides him with this information at no cost.

1. A method for providing details of a service to an end user comprising:
(i) said end user dialing a single access telephone number, said single access telephone number connecting said end user to a human operator;
(ii) said end user requesting from said operator details of a service; and
(iii) said operator providing said end user with said details;
wherein said operator obtains said details from a provider of said service.

2. A method according to claim 1 wherein calling said single access telephone number is without charge.

3. A method according to claim 1 further comprising the step of said operator connecting said end user to said service by telephone.

4. A method according to claim 1 wherein said operator provides said end user with the details of a plurality of service providers.

5. A method according to claim 1 wherein the cost of the telephone call of the end user to the operator is billed to the provider of the service whose details were provided by the operator to the end user.

6. A method according to claim 1 wherein said service comprises different types of services, and said operator possesses a list of one or more service providers for each type of service.

7. A method according to claim 1 wherein the provider of said service compensates said operator for including the details of its service in the lists of service providers.

8. A method according to claim 7 wherein each service provider of said type of service is chosen only once until all of the service providers of said type of service have been chosen.

9. A method according to claim 7 wherein said operator creates a subset of service providers which fulfill the requirements of said end user and chooses said service provider from said subset, said requirements including:
(i) type of service;
(ii) geographical location of said end user and said provider of said service; and
(iii) availability of said service.

10. A method according to claim 9 wherein said operator randomly chooses said service providers from said subset.

11. A method according to claim 10 wherein the details of said service provider appear in said subset a plurality of times, thereby increasing the probability that the service provider will be chosen.

12. A system for providing details of a service to an end user comprising:
(i) a collection of the details of service providers of different types of services;
(ii) a human telephone operator; and
(iii) a single access telephone number through which the end user may contact the operator.
